(19) United States
(12) Patent Application Publication
(10) Pub. No.: US 2004/0264938 A1
(43) Pub. Date: Dec. 30, 2004

(54) Audio event detection recording apparatus and method

(76) Inventor: Matthew D. Felder, Austin, TX (US)

Correspondence Address: Bruce E. Garlick, P.O. Box 160727, Austin, TX, 78716-0727, US

(21) Appl. No.: 10/607,682

(22) Filed: Jun. 27, 2003

(51) Int. Cl. H04N 5/76

(52) U.S. Cl. 386/96

(57) ABSTRACT

A system for digitally recording and time stamping an input audio signal during an audio event includes an input, an audio event detection module, a digital data recording and time-stamping module, and a memory. The input receives the input audio signal. The audio event detection module operably couples to the input and determines whether the input audio signal satisfies an audio event threshold. The digital data recording and time-stamping module operably couples to the input and to the audio event detection module and records and time stamps the input audio signal when the audio event detection module determines that the audio event is ongoing. The memory operably couples to the digital data recording and time-stamping module. The digital data recording and time-stamping module records the input audio signal in the memory.

### BACKGROUND OF THE INVENTION

1. Technical Field of the Invention

This invention relates generally to portable electronic equipment and more particularly to a multi-function handheld device.

2. Description of Related Art

As is known, integrated circuits are used in a wide variety of electronic equipment, including portable, or handheld, devices. Such handheld devices include personal digital assistants (PDA), CD players, MP3 players, DVD players, AM/FM radio, a pager, cellular telephones, computer memory extension that plugs into a port such as a Universal Serial Bus (USB) port, etc. Each of these handheld devices includes one or more integrated circuits to provide the functionality of the device. For example, a portable memory module (memory stick, etc.) may include an integrated circuit for interfacing with a computer (e.g., personal computer, laptop, server, workstation, etc.) via one of the ports of the computer (e.g., Universal Serial Bus, parallel port, etc.) and at least one other memory integrated circuit (e.g., flash memory). As such, when the portable memory module is coupled to a computer, data can be read from and written to the memory of the memory module. Accordingly, a user may store personalized information (e.g., presentations, Internet access account information, etc.) on his/her portable memory module and use any computer to access the information.

As another example, an MP3 player may include multiple integrated circuits to support the storage and playback of digitally formatted audio data (i.e., formatted in accordance with the MP3 specification). As is known, one integrated circuit may be used for interfacing with a computer, another integrated circuit for generating a power supply voltage, another for processing the storage and/or playback of the digitally formatted audio data, and still another for rendering the playback of the digitally formatted audio data audible.

Integrated circuits have enabled the creation of a plethora of handheld devices, however, to be “wired” in today's electronic world, a person needs to possess multiple handheld devices. For example, one may own a cellular telephone for cellular telephone service, a PDA for scheduling, address book, etc., one or more portable memory modules for extended memory functionality, an MP3 player for storage and/or playback of digitally recorded music, a radio, etc. Thus, even though a single handheld device may be relatively small, carrying multiple handheld devices on one's person can become quite burdensome.

It would be useful to employ a handheld device to perform audio event recording. An example of such a need relates to the recording of audio events surrounded in time by silence, e.g., the barking of a neighbor's dog during the nighttime. While one may desire to make an audio recording for the duration of the night, this would consume the memory of the handheld device and cause the handheld device battery to run down, typically long before the recording was complete. Therefore, a need exists for a handheld device that would be capable of performing audio event recording without draining its batteries in a relatively short period of time.

### BRIEF SUMMARY OF THE INVENTION

An apparatus and method of the present invention substantially meets these needs and others. An apparatus for digitally recording and time stamping an input audio signal during an audio event includes an input, an audio event detection module, a digital data recording and time-stamping module, and a memory. The input receives the input audio signal. The audio event detection module operably couples to the input and determines whether the input audio signal satisfies an audio event threshold. The digital data recording and time-stamping module operably couples to the input and to the audio event detection module and records and time stamps the input audio signal into the memory when the audio event detection module determines that the audio event is ongoing. The digital data recording and time-stamping module may record the input audio signal corresponding audio event according to an audio recording standard selected from the group consisting of PCM, MP3, WMA —Windows Media Architecture-, MP3 PRO, Ogg Vorbis, and AAC—Advanced Audio Coding.

The apparatus may include a real-time clock module operably coupled to the digital data recording and time-stamping module that provides a real-time clock used for time-stamping the input audio signal. The audio event detection module may include a voltage level monitor that operably couples to the input and that determines a voltage level of the input audio signal. With this structure, the audio event detection module determines whether the input audio signal satisfies an audio event threshold by comparing the voltage level of the input signal to a voltage level threshold. By monitoring the voltage of the input audio signal, the audio event detection module determines, in a simple but accurate manner, the power of the input audio signal to determine whether an audio event is ongoing.

The audio event detection module may further include an Analog-to-Digital-Converter (ADC) operably coupled to the input that samples the input audio signal to produce digital audio data. With this structure, the audio event detection module analyzes the digital audio data to produce a frequency characterization of the digital audio data. The audio event detection module compares the frequency characterization of the digital audio data to a frequency domain template of the audio event threshold. Alternately, the audio event detection module analyzes the digital audio data to produce a time domain characterization of the digital audio data. With this operation, the audio event detection module compares the time domain characterization of the digital audio data to the audio event threshold, which includes time domain based components.

The digital data recording and time-stamping module includes an ADC that samples the input audio signal to produce digital audio data. The ADC may be a low-resolution ADC or a high-resolution ADC, the high-resolution ADC consuming more power than the low-resolution ADC. In some operations the resolution provided by the low-resolution ADC is sufficient for producing the digital audio data.

Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a schematic block diagram of a handheld device and corresponding integrated circuit in accordance with the present invention;

FIG. 2 is a schematic block diagram of another handheld device and corresponding integrated circuit in accordance with the present invention;

FIG. 3 is a schematic block diagram of another integrated circuit in accordance with the present invention;

FIG. 4 is a schematic block diagram illustrating a first embodiment of a portion of the integrated circuit of FIGS. 1-3 showing in more detail components thereof used for audio event monitoring and recording;

FIG. 5 is a flow chart illustrating operation for digitally recording and time stamping an input audio signal during an audio event according to the present invention;

FIG. 6 is a schematic block diagram illustrating a second embodiment of a portion of the integrated circuit of FIGS. 1-3 showing in more detail components thereof used for audio event monitoring and recording; and

FIG. 7 is a schematic block diagram illustrating a third embodiment of a portion of the integrated circuit of FIGS. 1-3 showing in more detail components thereof used for audio event monitoring and recording.

### DETAILED DESCRIPTION OF THE INVENTION

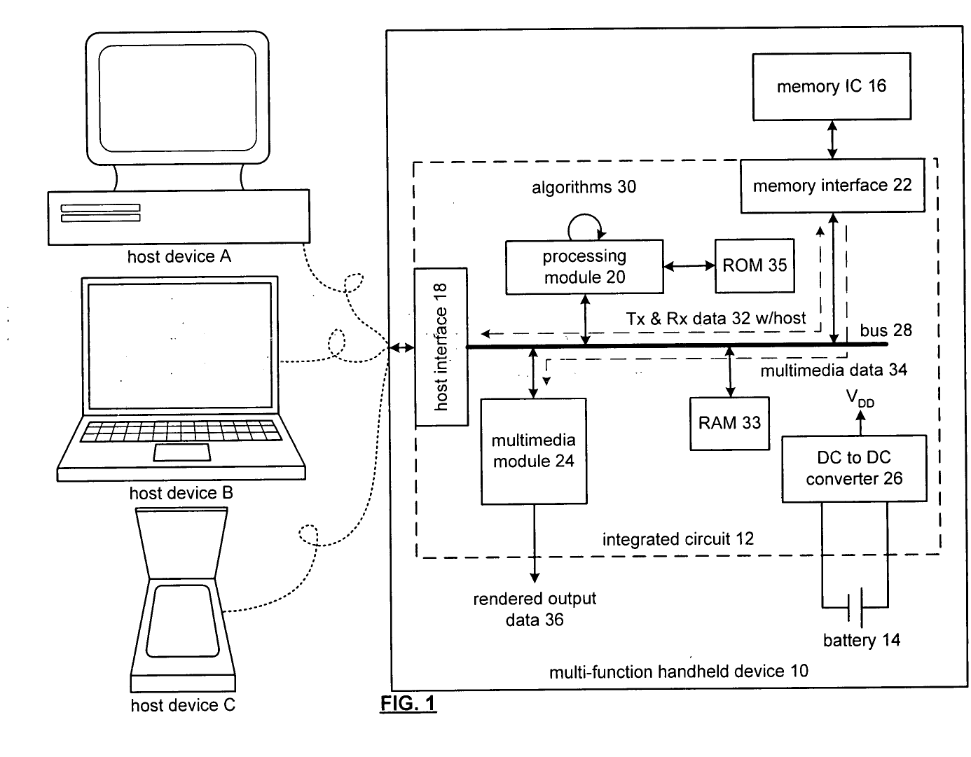

FIG. 1 is a schematic block diagram of a multi-function handheld device 10 and corresponding integrated circuit 12 operably coupled to a host device A, B, or C. The multi-function handheld device 10 also includes memory integrated circuit (IC) 16 and a battery 14. The integrated circuit 12 includes a host interface 18, a processing module 20, a memory interface 22, a multimedia module 24, a DC-to-DC converter 26, and a bus 28. The multimedia module 24 alone or in combination with the processing module 20 provides the functional circuitry for the integrated circuit 12. The DC-to-DC converter 26, which may be constructed in accordance with the teaching of U.S. Pat. No. 6,204,651, entitled METHOD AND APPARATUS FOR REGULATING A DC VOLTAGE, provides at least a first supply voltage to one or more of the host interface 18, the processing module 20, the multimedia module 24, and the memory interface 22. The DC-to-DC converter 26 may also provide V_{DD} to one or more of the other components of the handheld device 10.

When the multi-function handheld device 10 is operably coupled to a host device A, B, or C, which may be a personal computer, workstation, server (which are represented by host device A), a laptop computer (host device B), a personal digital assistant (host device C), and/or any other device that may transceive data with the multi-function handheld device, the processing module 20 performs at least one algorithm 30, where the corresponding operational instructions of the algorithm 30 are stored in memory 16 and/or in memory incorporated in the processing module 20. The processing module 20 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 20 implements one or more of its functions via a state machine, analog circuitry, digital circuitry, and/or logic circuitry, the associated memory storing the corresponding operational instructions is embedded with the circuitry comprising the state machine, analog circuitry, digital circuitry, and/or logic circuitry.

With the multi-function handheld device 10 in the first functional mode, the integrated circuit 12 facilitates the transfer of data between the host device A, B, or C and memory 16, which may be non-volatile memory (e.g., flash memory, disk memory, SDRAM) and/or volatile memory (e.g., DRAM). In one embodiment, the memory IC 16 is a NAND flash memory that stores both data and the operational instructions of at least some of the algorithms 30.

In this mode, the processing module 30 retrieves a first set of operational instructions (e.g., a file system algorithm, which is known in the art) from the memory 16 to coordinate the transfer of data. For example, data received from the host device A, B, or C (e.g., Rx data) is first received via the host interface module 18. Depending on the type of coupling between the host device and the handheld device 10, the received data will be formatted in a particular manner. For example, if the handheld device 10 is coupled to the host device via a USB cable, the received data will be in accordance with the format proscribed by the USB specification. The host interface module 18 converts the format of the received data (e.g., USB format) into a desired format by removing overhead data that corresponds to the format of the received data and storing the remaining data as data words. The size of the data words generally corresponds directly to, or a multiple of, the bus width of bus 28 and the word line size (i.e., the size of data stored in a line of memory) of memory 16. Under the control of the processing module 20, the data words are provided, via the memory interface 22, to memory 16 for storage. In this mode, the handheld device 10 is functioning as extended memory of the host device (e.g., like a portable memory module).

In furtherance of the first functional mode, the host device may retrieve data (e.g., Tx data) from memory 16 as if the memory were part of the computer. Accordingly, the host device provides a read command to the handheld device, which is received via the host interface 18. The host interface 18 converts the read request into a generic format and provides the request to the processing module 20. The processing module 20 interprets the read request and coordinates the retrieval of the requested data from memory 16 via the memory interface 22. The retrieved data (e.g., Tx data) is provided to the host interface 18, which converts the format of the retrieved data from the generic format of the handheld device into the format of the coupling between the handheld device and the host device. The host interface 18 then provides the formatted data to the host device via the coupling.

The coupling between the host device and the handheld device may be a wireless connection or a wired connection. For instance, a wireless connection may be in accordance with Bluetooth, IEEE 802.1(a), (b) or (g), and/or any other wireless LAN (local area network) protocol, IrDA, etc. The wired connection may be in accordance with one or more Ethernet protocols, Firewire, USB, etc. Depending on the particular type of connection, the host interface module 18 includes a corresponding encoder and decoder. For example, when the handheld device 10 is coupled to the host device via a USB cable, the host interface module 18 includes a USB encoder and a USB decoder.

As one of average skill in the art will appreciate, the data stored in memory 16, which may have 64 Mbytes or greater of storage capacity, may be text files, presentation files, user profile information for access to varies computer services (e.g., Internet access, email, etc.), digital audio files (e.g., PCM files, MP3 files, WMA —Windows Media Architecture-, MP3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format. As one of average skill in the art will further appreciate, when the handheld device 10 is coupled to the host device A, B, or C, the host device may power the handheld device 10 such that the battery is unused.

When the handheld device 10 is not coupled to the host device, the processing module 20 executes an algorithm 30 to detect the disconnection and to place the handheld device in a second operational mode. In the second operational mode, the processing module 20 retrieves, and subsequently executes, a second set of operational instructions from memory 16 to support the second operational mode. For example, the second operational mode may correspond to PCM playback, PCM recording, MP3 file playback, digital recording, MPEG file playback, JPEG file playback, text messaging display, cellular telephone functionality, and/or AM/FM radio reception.

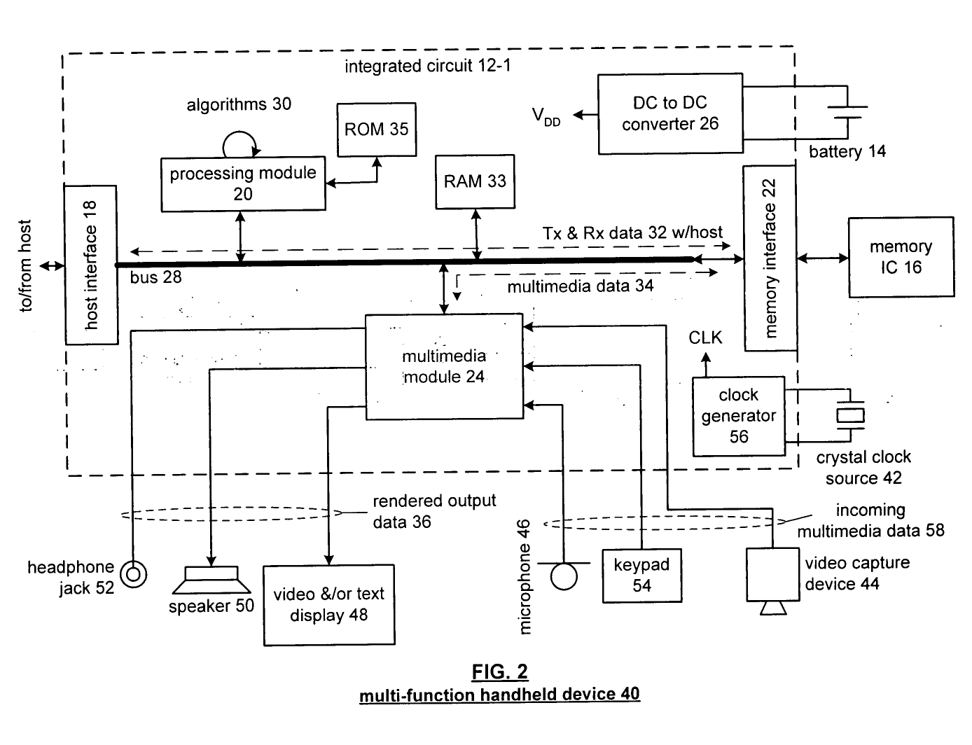

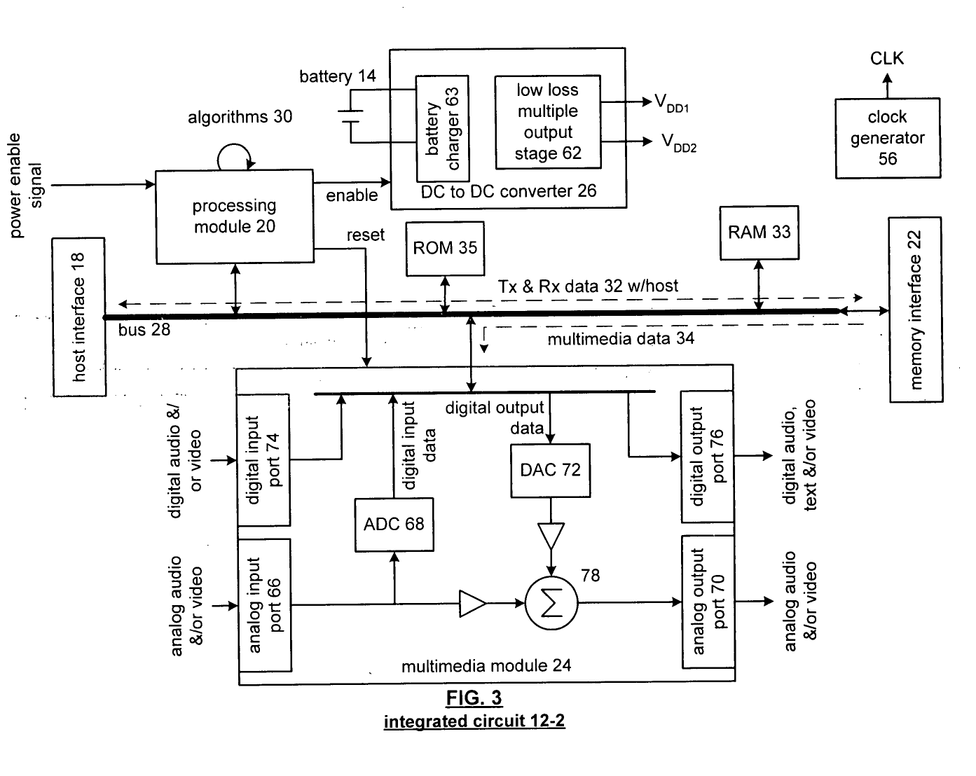

In the second operational mode, under the control of the processing module 20 executing the second set of operational instructions, the multimedia module 24 retrieves multimedia data 34 from memory 16. The multimedia data 34 includes at least one of digitized audio data, digital video data, and text data. Upon retrieval of the multimedia data, the multimedia module 24 converts the data 34 into rendered output data 36. For example, the multimedia module 24 may convert digitized data into analog signals that are subsequently rendered audible via a speaker or via a headphone jack. In addition, or in the alternative, the multimedia module 24 may render digital video data and/or digital text data into RGB (red-green-blue), YUV, etc., data for display on an LCD (liquid crystal display) monitor, projection CRT, and/or on a plasma type display. The multimedia module 24 will be described in greater detail with reference to FIGS. 2 and 3.

As one of average skill in the art, the handheld device 10 may be packaged similarly to a memory device that couples to a port (portable memory module), a cellular telephone, pager (e.g., text messaging), a PDA, an MP3 player, a radio, and/or a digital dictaphone and offer the corresponding functions of multiple ones of the handheld devices (e.g., provide a combination of a portable memory module and MP3 player/recorder, a combination of a portable memory module, MP3 player/recorder, and a radio, a combination of a portable memory module, MP3 player/recorder, and a digital dictaphone, combination of a portable memory module, MP3 player/recorder, radio, digital dictaphone, and cellular telephone, etc.).

FIG. 2 is a schematic block diagram of another handheld device 40 and a corresponding integrated circuit 12-1. In this embodiment, the handheld device 40 includes the integrated circuit 12-1, the battery 14, the memory 16, a crystal clock source 42, one or more multimedia input devices (e.g., one or more video capture device(s) 44, keypad(s) 54, microphone(s) 46, etc.), and one or more multimedia output devices (e.g., one or more video and/or text display(s) 48, speaker(s) 50, headphone jack(s) 52, etc.). The integrated circuit 12-1 includes the host interface 18, the processing module 20, the memory interface 22, the multimedia module 24, the DC-to-DC converter 26, and a clock generator 56, which produces a clock signal (CLK) for use by the other modules. As one of average skill in the art will appreciate, the clock signal CLK may include multiple synchronized clock signals at varying rates for the various operations of the multi-function handheld device.

Handheld device 40 functions in a similar manner as handheld device 10 when exchanging data with the host device (i.e., when the handheld device is in the first operational mode). In addition, while in the first operational mode, the handheld device 40 may store digital information received via one of the multimedia input devices 44, 46, and 54. For example, a voice recording received via the microphone 46 may be provided as multimedia input data 58, digitized via the multimedia module 24 and digitally stored in memory 16. Similarly, video recordings may be captured via the video capture device 44 (e.g., a digital camera, a camcorder, VCR output, DVD output, etc.) and processed by the multimedia module 24 for storage as digital video data in memory 16. Further, the key pad 54 (which may be a keyboard, touch screen interface, or other mechanism for inputting text information) provides text data to the multimedia module 24 for storage as digital text data in memory 16. In this extension of the first operational mode, the processing module 20 arbitrates write access to the memory 16 among the various input sources (e.g., the host and the multimedia module).

When the handheld device 40 is in the second operational mode (i.e., not connected to the host), the handheld device may record and/or playback multimedia data stored in the memory 16. Note that the data provided by the host when the handheld device 40 was in the first operational mode includes the multimedia data. The playback of the multimedia data is similar to the playback described with reference to the handheld device 10 of FIG. 1. In this embodiment, depending on the type of multimedia data 34, the rendered output data 36 may be provided to one or more of the multimedia output devices. For example, rendered audio data may be provided to the headphone jack 52 an/or to the speaker 50, while rendered video and/or text data may be provided to the display 48.

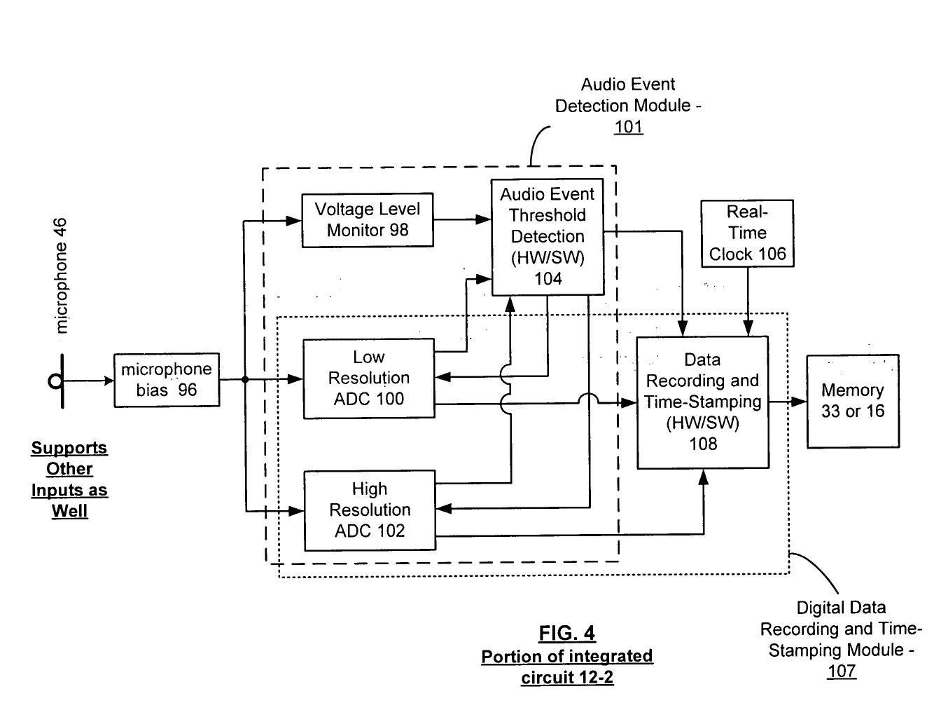

The handheld device 40 may also record multimedia data 34 while in the second operational mode. For example, the handheld device 40 may store digital information received via one of the multimedia input devices 44, 46, and 54. These operations will be described further in detail with reference to FIGS. 4-7.

FIG. 3 is a schematic block diagram of an integrated circuit 12-2 that may be used in a multi-function handheld device. The integrated circuit 12-2 includes the host interface 18, the processing module 20, the DC-to-DC converter 26, memory 60, the clock generator 56, the memory interface 22, the bus 28 and the multimedia module 24. The DC-to-DC converter 26 includes a first output section 62, and a second output section 64 to produce a first and second output voltage (V_{DD1} and V_{DD2}), respectively. Typically, V_{DD1} will be greater that V_{DD2}; where V_{DD1} is used to source analog sections of the processing module 20, the host interface 18, the memory interface 22, and/or the multimedia module 22 and V_{DD2} is used to source the digital sections of these modules. The DC-to-DC converter 26 may further include a battery charger 63 and a low loss multiple output stage 62. The battery charger 63 is operable to charge the battery 14 from power it receives via the physical coupling (e.g., via a USB cable) to the host device when the multi-function handheld device is physically coupled to the host device. The particular implementation of the battery charger 63 is dependent on the type of battery being used and such implementations are known in the art, thus no further discussion will be provided regarding the battery charger 63 except to further illustrate the concepts of the present invention.

The multimedia module 24 includes an analog input port 66, an analog to digital converter (ADC) 68, an analog output port 70, a digital to analog converter (DAC) 72, a digital input port 74, a digital output port 76, and an analog mixing module 78. The analog input port 66 is operably coupled to receive analog input signals from one or more sources including a microphone, an AM/FM tuner, a line in connection (e.g., headphone jack of a CD player), etc. The received analog signals are provided to the ADC 68, which produces digital input data therefrom. The digital input data may be in a pulse code modulated (PCM) format and stored as such, or it may be provided to the processing module 20 for further audio processing (e.g., compression, MP3 formatting, etc.) The digital input data, or the processed version thereof, is stored in memory 16 as instructed by the processing module 20.

The digital input port 74 is operably coupled to receive digital audio and/or video input signals from, for example, a digital camera, a camcorder, etc. The digital audio and/or video input signals may be stored in memory 16 under the control of the processing module 20. As one of average skill in the art will appreciate, the audio and/or video data (which was inputted as analog signals or digital signals) may be stored as raw data (i.e., the signals received are stored as is in designated memory locations) or it may be stored as processed data (i.e., compressed or uncompressed PCM data, MPEG data, MP3 data, WMA data, etc.).

When the output of the DAC 72 is the only input to the mixing module 78, the mixing module 78 outputs the analog video and/or audio output data to the analog output port 70. The analog output port 70 may be coupled to one or more of the speaker, headphone jack, and a video display. The mixing module 78 may mix analog input signals received via the analog input port 66 with the output of DAC 72 to produce a mixed analog signal that is provided to the analog output port 70. Note that the buffers in series with the inputs of the mixing module 78 may have their gains adjusted and/or muted to enable selection of the signals at various gain settings provided to the mixing module 78 and subsequently outputted via the analog output port 70.

The digital output port 76 is operably coupled to output the digital output data (i.e., the multimedia data 34 in a digital format). The digital output port 76 may be coupled to a digital input of a video display device, another handheld device for direct file transfer, etc.

As one of average skill in the art will appreciate, the multimedia module 24 may include more or less components than the components shown in FIG. 3 or include multiple analog and/or digital input and/or output ports. For example, for a playback mode of digital audio files, the multimedia module 24 may only include the DAC 72 and the analog output port 70 that are coupled to the headphone jack and/or to the speaker. As another example, for recording voice samples (i.e., as a digital dictaphone), the multimedia module 24 may include the analog input port 66 coupled to the microphone and the ADC.

FIG. 4 is a schematic block diagram illustrating a first embodiment of a portion of the integrated circuit of FIGS. 1-3 showing in more detail components thereof used for audio event monitoring and recording. The structure of FIG. 4 includes an input that couples to a microphone 46 and that may include a microphone bias circuit 96. The input receives an input audio signal from the microphone 46. In other applications, the input audio signal may be received from other audio sources as well, e.g., baby monitor analog output, short wave radio analog output, two-way radio analog output, etc. The present invention is directed toward the application of recording and time stamping the input audio signal upon the detection of audio event. As will be described further hereafter herein, the present invention accomplishes these goals and also minimizes power consumption. Thus, a hand-held device operating according to the present invention will perform these tasks for a significant time duration while being battery powered.

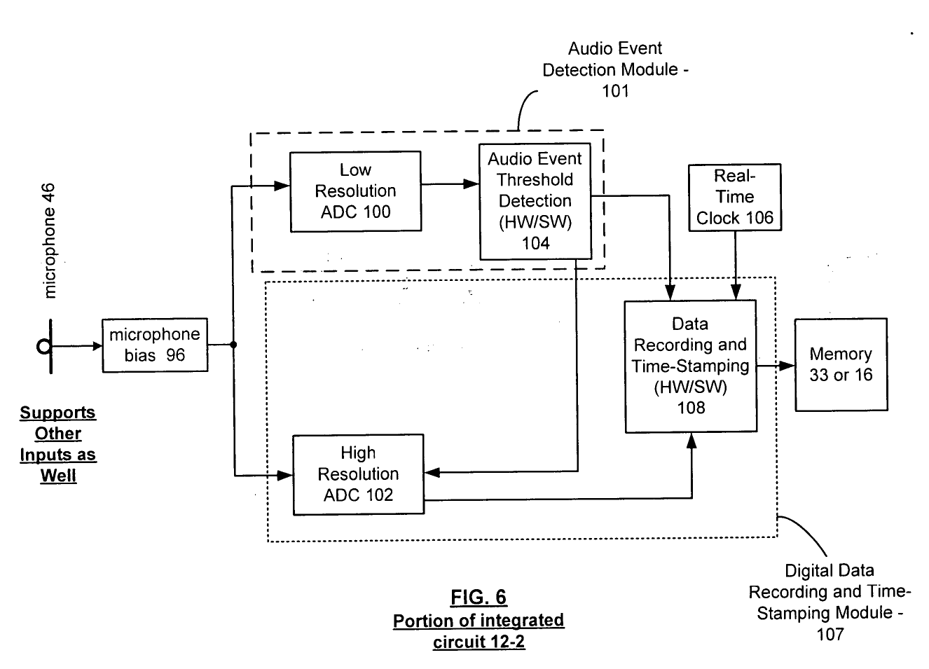

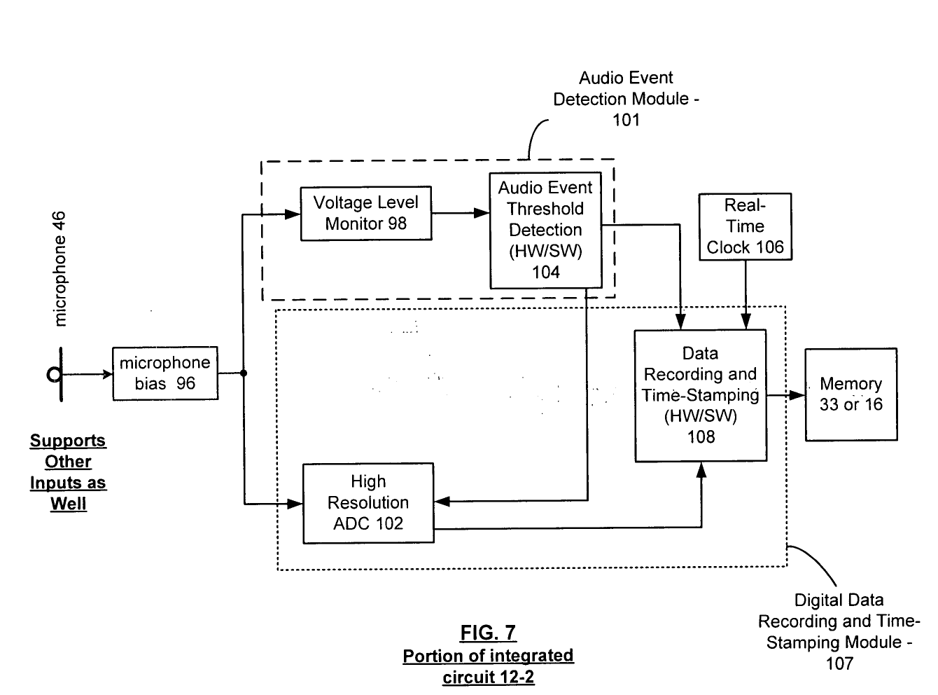

The structure of FIG. 4 includes an audio event detection module 101 operably coupled to the input that determines whether the input audio signal satisfies an audio event threshold. In the embodiment of FIG. 4, the audio event detection module 101 includes audio event threshold detection hardware and/or software (HW/SW) 104 and also includes one or more of a voltage level monitor 98 (power level monitor), a low-resolution Analog-to-Digital-Converter (ADC) 100, and a high-resolution ADC 102. As will be described further with reference to FIGS. 6 and 7, in differing embodiments, the combination of elements that serves as the audio event detection module 101 differs in each embodiment.

The structure of FIG. 4 also includes a digital data recording and time-stamping module 107 that includes data recording and time-stamping hardware and/or software (HW/SW) 108 and at least one of a low-resolution ADC 100 and/or a high-resolution ADC 102. The digital data recording and time-stamping module 107 records and time stamps the input audio signal when the audio event detection module 101 determines that the audio event is ongoing. The digital data recording and time-stamping module 107 receives a real-time clock from real-time clock module 106 that it uses to time stamp the input audio signal during recording. Finally, the structure of FIG. 4 includes memory 33 or 16 operably coupled to the digital data recording and time-stamping module 107 in which the digital data recording and time-stamping module 107 records and time stamps the input audio signal.

As will be described further with reference to FIGS. 6 and 7, in the embodiments described herein, the combination of elements that makes up the digital data recording and time-stamping module 107 and/or that makes up the audio event detection module 101 may vary from embodiment to embodiment. Further, the digital data recording and time-stamping module 107 may be implemented in part by the processing module 20 and the algorithms 30 operating thereon;

During reduced power modes of operation, the processing module 20 (and the algorithms 30 operating thereon) are disabled, e.g., powered down. The audio event detection module 101 and the real-time clock 106 remain powered. While major power consuming portions of the integrated circuit 12-2 are powered down, the audio event detection module 101 (contained in the multimedia module 24, for example) continues to monitor the input audio signal awaiting the audio event. In this manner, battery life is extended while the input audio signal is still monitored for the detection of the audio event. When the audio event is detected by the audio event detection module 101, other components of the integrated circuit 12-2 are powered so that the input audio event signal is recorded and time stamped by the digital data recording and time-stamping module 107.

With the structure of FIG. 4 the digital data recording and time-stamping module 107 may record the input audio signal according to an audio recording standard selected, e.g., PCM, MP3, WMA —Windows Media Architecture-, PCM, MP3 PRO, Ogg Vorbis, AAC—Advanced Audio Coding, etc. 21. The integrated circuit 12-2 may be constructed to be compliant with Universal Serial Bus (USB) Mass-Storage operations.

With the structure of FIG. 4, various techniques are employed to detect the audio event. With a first technique, the low-resolution ADC 100 or the high-resolution ADC 102 samples the input audio signal to produce digital audio data. The audio event threshold detection HW/SW 104 then analyzes the digital audio data to produce a frequency characterization of the digital audio data. The audio event threshold detection HW/SW 104 then compares the frequency characterization of the digital audio data to a frequency domain template of the audio event threshold. Based upon this comparison, the audio event threshold detection HW/SW 104 then determines whether the audio event is occurring.

Using another technique, the low-resolution ADC 100 or the high-resolution ADC 102 samples the input audio signal to produce digital audio data. The audio event threshold detection HW/SW 104 then analyzes the digital audio data to produce a time domain characterization of the digital audio data. The audio event threshold detection HW/SW 104 then compares the time domain characterization of the digital audio data to the audio event threshold, which includes time domain based components. Based upon this comparison, the audio event threshold detection HW/SW 104 then determines whether the audio event is occurring.

With any of these structures, one or both of the low-resolution ADC 100 and the high-resolution ADC 102 is powered down during pre-determined time periods corresponding to when the audio event is expected to reduce energy consumption. For example, using a barking dogs in the middle of the night scenario, the ADCs 100 and 102 would be powered down during the day and then powered up at night, automatically by the integrated circuit 12-2 based upon the real-time clock.

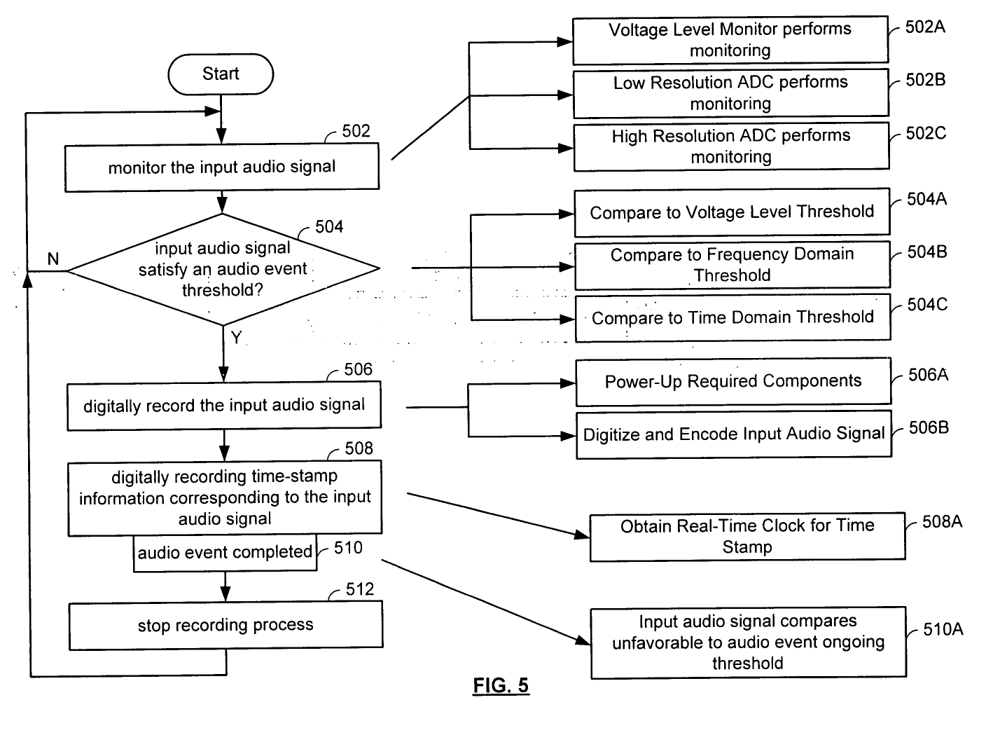

FIG. 5 is a flow chart illustrating operation for digitally recording and time stamping an input audio signal during an audio event according to the present invention. The method commences with monitoring the input audio signal (step 502). Next, the method includes determining whether the input audio signal satisfies an audio event threshold (step 504). If the input audio signal does not satisfy the audio event threshold, operation returns to step 502 where the monitoring continues. When the input audio signal satisfies the audio event threshold to indicate the existence of the audio event, as determined at step 504, the method includes digitally recording the input audio signal (step 506). Finally, the method includes, concurrently with digitally recording the input audio signal, recording time-stamp information corresponding to the input audio signal (step 508).

In a first operation of steps 502 and 504, determining whether the input audio signal satisfies an audio event threshold includes: (1) continuously monitoring a voltage level of the input audio signal (to produce an indication of the power in the input audio signal, step 502A); and (2) when the voltage level (power level) of the input audio signal exceeds a voltage level threshold (power level threshold, step 504A), determining that the audio event is ongoing. In a second operation of steps 502 and 504, determining whether the input audio signal satisfies an audio event threshold includes: (1) continuously converting the input audio signal that is received in an analog format to digital audio data and analyzing the digital audio data to produce a frequency characterization of the digital audio data (step 502B); and (2) comparing the frequency characterization of the digital audio data to a frequency domain template of the audio event threshold (step 504B). In this frequency analysis operation, the frequency domain template of the audio event threshold may include frequency components that accurately correspond to an expected audio event, e.g., barking dogs. With this characterization, incorrect detections of the audio event are minimized while the detection of the expected audio event is more likely.

In a third operation of steps 502 and 504, determining whether the input audio source satisfies an audio event threshold includes: (1) continuously converting the input audio signal that is received in an analog format to digital audio data and analyzing the digital audio data to produce a time domain characterization of the digital audio data (step 502C); and (2) comparing the time domain characterization of the digital audio data to at least one time domain component of the audio event threshold (step 504C). The time domain characterization may include, for example, the average input audio signal level over a period of time, the percentage of time over a time interval that the input audio signal level exceeds a threshold, the percentage of time over the time interval that the input audio signal level is less than a threshold, etc.

In the digital recording of step 506, operation may require powering-up components, e.g., processing module 20 and/or memory 33 or 16, that were previously not required for the recording process (step 506A) and/or digitizing and encoding the input audio signal (step 506B). With any of these options, digitally recording the input audio of step 506 may be performed according to an audio recording standard, e.g., PCM, MP3, WMA —Windows Media Architecture-, PCM, MP3 PRO, Ogg Vorbis, and AAC—Advanced Audio Coding. Time-stamp information may be derived from a real-time clock such that the input audio signal is time-stamped with real-time clock data when digitally recorded (step 508A). The method of FIG. 5 may also include monitoring the input audio signal only during pre-determined time periods corresponding to when the audio event is expected in order to reduce energy consumption.

Recording of the input audio signal at step 508 will continue until the handheld device determines that the audio event is no longer ongoing, i.e., the audio event is complete (step 510). This detection process is completely analogous to the detection of the audio event itself and uses the same components. In particular, the voltage level, the frequency domain characterization, and/or the time domain characterization of the input audio signal is compared to an audio event ongoing threshold. This threshold may be the same or similar to the previously described thresholds, but in an opposite application. When the input audio signal compares unfavorably to the threshold, the recording process is stopped (step 512) and monitoring begins again at step 502. At step 512, components may be powered down that are not required during the monitoring process but that were required during the recording process.

FIG. 6 is a schematic block diagram illustrating a second embodiment of a portion of the integrated circuit of FIGS. 1-3 showing in more detail components thereof used for audio event monitoring and recording. In the structure of FIG. 6, as contrasted to the structure of FIG. 4, the audio event detection module 101 includes a low-resolution ADC 100 and the audio event threshold detection HW/SW 104. Further, the digital data recording and time stamping module 107 includes a high resolution ADC 102 and the data recording and time stamping HW/SW 108. In this embodiment, the low resolution ADC 100 samples the input audio signal to produce low-resolution digital audio data. The low-resolution ADC 100 may be a simple comparator with a one-bit output that compares the input signal to a voltage threshold. The audio event threshold detection HW/SW 104 uses the low-resolution digital audio data to determine whether the input audio signal satisfies an audio event threshold. Further, the high-resolution ADC 102 operably couples to the input and to the digital data recording and time-stamping HW/SW 108. The high-resolution ADC 102 samples the input audio signal to produce high-resolution digital audio data. In the embodiment of FIG. 6, the digital data recording and time-stamping HW/SW 108 records the high-resolution digital audio data.

FIG. 7 is a schematic block diagram illustrating a third embodiment of a portion of the integrated circuit of FIGS. 1-3 showing in more detail components thereof used for audio event monitoring and recording. In the structure of FIG. 6, the voltage level monitor 98 provides a voltage level output signal to the audio event threshold detection HW/SW 104, the voltage level signal providing both an indication of the voltage of the input audio signal and the power of the input audio signal. The event threshold detection HW/SW 104 uses the voltage level output signal to determine whether the input audio signal satisfies an audio event threshold. Further, the high-resolution ADC 102 operably couples to the input and to the digital data recording and time-stamping HW/SW 108. The high-resolution ADC 102 samples the input audio signal to produce high-resolution digital audio data. In the embodiment of FIG. 7, the digital data recording and time-stamping HW/SW 108 records the high-resolution digital audio data.

With the structure of FIG. 7, the voltage level monitor 98 and the audio event threshold detection HW/SW 104 could also perform energy and time duration analysis. In such case, the voltage level monitor 98 would include a comparator and a counter. If the input audio signal exceeds a voltage threshold for a certain number of clock cycles, as determined by the count of the counter, an audio event is detected. Further, if the input audio signal fails to exceed the voltage threshold for a certain number of cycles, or fails to meet an audio event ongoing threshold (as described with reference to FIG. 5), the audio event is determined to have ceased and recording stops.

In still another embodiment (not shown), the integrated circuit 12-2 includes only the voltage level monitor 98 and the low-resolution ADC 100. The voltage level monitor 98 output is employed to determine whether the audio event is occurring and, if so, the low-resolution ADC 100 output is time stamped and recorded by the digital data recording and time-stamping HW/SW 108. With this structure, the monitoring, determining, and recording operations are at a very low power consumption operation, albeit at the risk of reduced resolution in the recorded information. For example, the high-resolution ADC 102 has a bandwidth across an audio spectrum of 20 Hz to 20 KHz. The low-resolution ADC 100, on the other hand, has a reduced bandwidth, e.g., 20 Hz to 5 KHz. Thus, while the quality of the stored information is lesser, the power consumption is also lesser. In many applications. e.g., the barking dogs application, the reduced bandwidth would typically serve the intended purpose of documenting whether, and at what times the dogs were barking.

The preceding discussion has presented a system-on-a-chip integrated circuit for use in a multi-function handheld device. As one of average skill in the art will appreciate, other embodiments may be derived from the teaching of the present invention, without deviating from the scope of the claims.

1. A method for digitally recording and time stamping an input audio signal during an audio event, the method comprising:
monitoring the input audio signal;
determining whether the input audio signal satisfies an audio event threshold;
when the input audio signal satisfies the audio event threshold to indicate the existence of the audio event, digitally recording the input audio signal; and
concurrently with digitally recording the input audio signal, recording time-stamp information corresponding to the input audio signal.

2. The method of claim 1, wherein digitally recording the input audio signal corresponding to the audio event is performed according to an audio recording standard selected from the group consisting of PCM encoding, MP3, WMA —Windows Media Architecture-, MP3 PRO, Ogg Vorbis, and AAC—Advanced Audio Coding.

3. The method of claim 1, wherein the time-stamp information is derived from a real-time clock such that the input audio signal is time-stamped with real-time clock data when digitally recorded.

4. The method of claim 1, wherein determining whether the input audio signal satisfies an audio event threshold comprises:
continuously monitoring a voltage level of the input audio signal; and
when the voltage level of the input audio signal exceeds a voltage level threshold, determining that the audio event is ongoing.

5. The method of claim 1, wherein determining whether the input audio signal satisfies an audio event threshold comprises:
continuously converting the input audio signal that is received in an analog format to digital audio data;
analyzing the digital audio data to produce a frequency characterization of the digital audio data; and
comparing the frequency characterization of the digital audio data to a frequency domain template of the audio event threshold.

6. The method of claim 1, wherein determining whether the input audio source satisfies an audio event threshold comprises:
continuously converting the input audio signal that is received in an analog format to digital audio data;
analyzing the digital audio data to produce a time domain characterization of the digital audio data; and
comparing the time domain characterization of the digital audio data to at least one time domain component of the audio event threshold.

7. The method of claim 1, wherein:
monitoring the input audio signal includes measuring a voltage level of the input audio signal;
the input audio signal satisfies the audio event threshold to indicate the existence of the audio event when the voltage level of the input audio signal compares favorably to a voltage level threshold; and
recording the input audio signal and recording time-stamp information corresponding to the input audio signal further comprises:
powering an Analog-to-Digital Converter (ADC) that was previously unpowered;
sampling the input audio signal with the ADC to produce digital audio data;
encoding the digital audio data to produce encoded digital audio data;
generating the time-stamp information from a real-time-clock corresponding to the encoded digital audio data; and
recording the encoded digital audio data and the time-stamp information.

8. The method of claim 7, wherein the ADC is a low-resolution ADC.

9. The method of claim 7, wherein the ADC is a high-resolution ADC.

10. The method of claim 1, wherein:
monitoring the input audio signal includes converting the input audio signal, received in an analog format, to a low-resolution digital audio data using a low-resolution Analog-to-Digital-Converter (ADC);
determining whether the input audio signal satisfies an audio event threshold includes comparing the low-resolution digital audio data to the audio event threshold; and
digitally recording the input audio signal includes:
converting the input audio signal, received in an analog format, to a high-resolution digital audio data using a high-resolution ADC;
encoding the high-resolution digital audio to produce encoded digital audio data;
generating the time-stamp information from a real-time-clock corresponding to the encoded digital audio data; and
recording the encoded digital audio data and the time-stamp information.

11. The method of claim 1, further comprising monitoring the input audio signal only during pre-determined time periods corresponding to when the audio event is expected in order to reduce energy consumption.

12. The method of claim 1, further comprising:
determining that the audio event is no longer ongoing; and
stopping the recording of the input audio signal.

13. An apparatus for digitally recording and time stamping an input audio signal during an audio event, the method comprising:
an input that receives the input audio signal;
an audio event detection module operably coupled to the input that determines whether the input audio signal satisfies an audio event threshold;
digital data recording and time-stamping module operably coupled to the input and to the audio event detection module that records and time stamps the input audio signal when the audio event detection module determines that the audio event is ongoing; and
memory operably coupled to the digital data recording and time-stamping module in which the digital data recording and time-stamping module records the input audio signal.

14. The apparatus of claim 13, wherein the digital data recording and time-stamping module records the corresponding audio event is performed according to an audio recording standard selected from the group consisting of PCM encoding, MP3, WMA —Windows Media Architecture-, MP3 PRO, Ogg Vorbis, and AAC—Advanced Audio Coding.

15. The apparatus of claim 13, further comprising a real-time clock module operably coupled to the digital data recording that provides a real-time clock used for time-stamping the input audio signal.

16. The apparatus of claim 13:
wherein the audio event detection module includes a voltage level monitor operably coupled to the input that determines a voltage level of the input audio signal; and
wherein the audio event detection module determines whether the input audio signal satisfies an audio event threshold by comparing the voltage level of the input signal to a voltage level threshold.

17. The apparatus of claim 13:
wherein the audio event detection module includes an Analog-to-Digital-Converter (ADC) operably coupled to the input that samples the input audio signal to produce digital audio data;
wherein the audio event detection module analyzes the digital audio data to produce a frequency characterization of the digital audio data; and
wherein the audio event detection module compares the frequency characterization of the digital audio data to a frequency domain template of the audio event threshold.

18. The apparatus of claim 13:
wherein the audio event detection module includes an Analog-to-Digital-Converter (ADC) operably coupled to the input that samples the input audio signal to produce digital audio data;
wherein the audio event detection module analyzes the digital audio data to produce a time domain characterization of the digital audio data; and
wherein the audio event detection module compares the time domain characterization of the digital audio data to the audio event threshold, which includes time domain based components.

19. The apparatus of claim 18, wherein the ADC is a low-resolution ADC.

20. The apparatus of claim 18, wherein the ADC is a high-resolution ADC.

21. The apparatus of claim 18, wherein the ADC is powered down during pre-determined time periods corresponding to when the audio event is expected to reduce energy consumption.

22. The apparatus of claim 13, wherein the apparatus is compliant with Universal Serial Bus (USB) Mass-Storage operations.

23. The apparatus of claim 13, further comprising a battery that powers the audio event detection module, the digital data recording and time-stamping module, and the memory.

24. The apparatus of claim 13:
wherein the audio event detection module includes a low-resolution Analog-to-Digital-Converter (ADC) operably coupled to the input and to the audio event detection module that samples the input audio signal to produce low-resolution digital audio data; and
digital data recording and time-stamping module includes a high-resolution ADC operably coupled to the input and to the audio event detection module that samples the input audio signal to produce high-resolution digital audio data.
